(19) United States
(12) Patent Application Publication
(10) Pub. No.: US 2020/0406207 A1
(43) Pub. Date: Dec. 31, 2020

(54) Emulsions and Methods of Preparation Thereof

(71) Applicant: Amarlane Foods Ltd., Modiin IIit (IL)

(72) Inventors: Itamar Ovadia Edery, Jerusalem (IL); David Gilad, Jerusalem (IL)

(21) Appl. No.: 16/074,087

(22) PCT Filed: Feb. 5, 2017
(86) PCT No.: PCT/IB2017/050624

§ 371 Date: Jul. 31, 2018

Related U.S. Application Data
(60) Provisional application No. 62/292,282, filed on Feb. 6, 2016.

(51) Int. Cl. B01F 17/00; A23D 7/005; A23D 7/05

(52) U.S. Cl. CPC B01F 17/0028; A23D 7/0053; B01F 2215/0067; A23D 7/05; A23D 7/0056

(57) ABSTRACT

A method comprising: (a) bringing water and oil to a temperature above the melting point of the oil; (b) combining oil and water in a ratio (W/W) between 2:1 and 5.7:1 (c) adding 0.5% to 2% W/W of Canna arrowroot powder relative to total weight of oil and water; (e) mixing to form an emulsion.

### RELATED APPLICATIONS

This application claims the benefit under 35 U.S.C. § 119(e) of provisional application U.S. 62/292,282 filed Feb. 6, 2016 and entitled “IMPROVED FOOD PRODUCTS COMPRISING OIL-IN-WATER DROPLETS WITH NATURAL THICKENER AS AN EMULSIFYING AGENT”; which is fully incorporated herein by reference.

### FIELD OF THE INVENTION

The invention is the field of emulsion technology.

### BACKGROUND OF THE INVENTION

Solid oil based products, such as margarine, butter, lard and shortening are standard ingredients in commercial baking. Many solid oil based products are produced by hydrogenation of oils, which are liquid at room temperature. Hydrogenation raises the melting point causing the oil to remain in the solid phase at room temperature.

Hydrogenation results in creation of trans-fatty acids. Public perception of trans-fats as “unhealthy” has led to the development of trans-fat free products, which are solid or spreadable, as opposed to liquid. Processes such as interesterification, fractionation, and the addition of monoglycerides and/or diglycerides are typically used to make the non-liquid trans-fat free products.

However, public perception of these alternative products as “unhealthy” is growing.

### SUMMARY OF THE INVENTION

One aspect of some embodiments of the invention relates to use of arrowroot powder as an emulsifier in emulsions, which do not contain a conventional surfactant, and/or emulsifier (such as lecithin or non-lecithin conventional emulsifiers). In some embodiments the arrowroot comprises Canna Indica (hereinafter “Canna”).

Another aspect of some embodiments of the invention relates to use of arrowroot powder as a stabilizer in emulsions containing a conventional surfactant and/or emulsifier (such as lecithin), a plant derived oil, and water. According to various exemplary embodiments of the invention the arrowroot powder comprises Maranta Arundinacea (hereinafter “Maranta”), Curcuma Angustifolia (hereinafter “Curcuma”) and/or Canna.

Additional aspects of some embodiments of the invention relate to food products based on an emulsion of oil, water and arrowroot (with or without lecithin or other emulsifiers). According to various exemplary embodiments of the invention the food products are solid (i.e. having a texture like butter or margarine), thick (i.e. having a texture like mayonnaise, salad dressing or crème patisserie) or creamy (i.e. having a texture like chocolate spread or dulce de leche).

It will be appreciated that the various aspects described above relate to solution of technical problems associated with emulsion preparation.

Alternatively or additionally, it will be appreciated that the various aspects described above relate to solution of technical problems associated with using oils in preparation of solid or semi-solid food products.

Alternatively or additionally, it will be appreciated that the various aspects described above relate to solution of technical problems related to regulating the texture and/or mouth feel of oil based food products.

In some exemplary embodiments of the invention there is provided a method including: (a) bringing water and oil to a temperature above the melting point of the oil; (b) combining oil and water in a ratio (W/W) between 2:1 and 5.7:1 (c) adding 0.5% to 2% W/W of Canna arrowroot powder relative to total weight of oil and water; and (e) mixing to form an emulsion. In some embodiments, the mixing is conducted in a high shear mixer. Alternatively or additionally, in some embodiments the method includes crystallizing the emulsion by cooling below a crystallization temperature of the oil. Alternatively or additionally, in some embodiments the adding 0.2% to 2% W/W of arrowroot includes adding arrowroot to water prior to combining oil and water. Alternatively or additionally, in some embodiments the adding 0.2% to 2% W/W of arrowroot includes adding arrowroot to oil prior to combining oil and water. Alternatively or additionally, in some embodiments the method includes tempering the emulsion. Alternatively or additionally, in some embodiments the arrowroot includes Marranta arrowroot in addition to Canna. Alternatively or additionally, in some embodiments the Arrowroot powder consists essentially of Canna Arrowroot. Alternatively or additionally, in some embodiments the arrowroot powder includes Curcuma arrowroot in addition to Canna. Alternatively or additionally, in some embodiments the temperature above a melting point of the oil is 22° C. to 80° C. Alternatively or additionally, in some embodiments the oil includes coconut oil. Alternatively or additionally, in some embodiments the oil consists essentially of coconut oil. Alternatively or additionally, in some embodiments includes any vegetable oil. Alternatively or additionally, in some embodiments no emulsifier selected from the group consisting of lecithin and non-lecithin conventional emulsifying agents is added.

In some exemplary embodiments of the invention there is provided a method including: (a) bringing water and oil to a temperature above the melting point of the oil; (b) combining oil and water in a ratio (W/W) between 2:1 and 5.7:1; (c) adding 0.2% to 2% W/W of arrowroot powder relative to total weight of oil and water; (d) adding 0.2% to 1.0% W/W of lecithin relative to total weight of oil and water; and (e) mixing to form an emulsion. In some embodiments, the mixing is conducted in a high shear mixer. Alternatively or additionally, in some embodiments the method includes crystallizing the emulsion by cooling below a crystallization temperature of the oil. Alternatively or additionally, in some embodiments the adding 0.2% to 2% W/W of arrowroot includes adding arrowroot to water prior to combining oil and water. Alternatively or additionally, in some embodiments the adding 0.2% to 1.0% W/W of lecithin includes adding lecithin to the oil before combining oil and water. Alternatively or additionally, in some embodiments the method includes tempering the emulsion. Alternatively or additionally, in some embodiments the arrowroot includes Marranta arrowroot. Alternatively or additionally, in some embodiments the arrowroot includes Curcuma arrowroot. Alternatively or additionally, in some embodiments the Arrowroot powder includes Canna Arrowroot. Alternatively or additionally, in some embodiments the Arrowroot powder includes a mixture of Maranta and Canna arrowroots. Alternatively or additionally, in some embodiments the temperature above a melting point of the oil is 22 degrees centigrade to 60 degrees centigrade. Alternatively or additionally, in some embodiments the oil includes coconut oil. Alternatively or additionally, in some embodiments the oil consists essentially of coconut oil. Alternatively or additionally, in some embodiments the oil includes any vegetable oil. Alternatively or additionally, in some embodiments the emulsion is a water in oil emulsion.

In some exemplary embodiments of the invention there is provided a composition including on a W/W basis: (a) 67-85% oil; (b) 15-33% water; and (c) 0.2 to 3.0% arrowroot relative to water; wherein the composition is an emulsion stable from below the melting temperature of the oil to at least 40° C. In some embodiments, the emulsion is stable to at least 90° C. Alternatively or additionally, in some embodiments the oil includes coconut oil. Alternatively or additionally, in some embodiments wherein the arrowroot includes Marranta. Alternatively or additionally, in some embodiments the arrowroot includes Canna. Alternatively or additionally, in some embodiments wherein the arrowroot includes Curcuma. Alternatively or additionally, in some embodiments the composition includes 0.15%-2.85% lecithin W/W relative to the oil.

In some exemplary embodiments of the invention there is provided a composition including on a W/W basis: (a) 67-85% coconut oil; (b) 15-33% water; and (c) 2.0 to 3.0% arrowroot relative to water; wherein the composition is an emulsion stable when heated to a temperature of 170° C. In some embodiments, the arrowroot includes Marranta. Alternatively or additionally, in some embodiments the arrowroot includes Canna. Alternatively or additionally, in some embodiments the composition includes 0.15%-2.85% lecithin W/W relative to the oil.

In some exemplary embodiments of the invention there is provided a composition including on a W/W basis: (a) 67-85% oil; (b) 15-33% water; and (c) 0.2 to 3.0% arrowroot relative to water; wherein the composition does not include lecithin yet is a stable emulsion at 4° C. to 90° C. In some embodiments, the arrowroot includes Canna. Alternatively or additionally, in some embodiments the oil includes a palm oil. Alternatively or additionally, in some embodiments the composition does not comprise a non-lecithin conventional emulsifier.

In some exemplary embodiments of the invention there is provided a composition including on a W/W basis: (a) 67-85% oil; (b) 15-33% water; and (c) 1.2 to 1.6% arrowroot relative to water; wherein the composition is a stable emulsion at 4° C. to 90° C. In some embodiments, the arrowroot includes Canna. Alternatively or additionally, in some embodiments the oil includes a palm oil and/or coconut oil. Alternatively or additionally, in some embodiments the composition includes no emulsifier other than the arrowroot.

In some exemplary embodiments of the invention there is provided a composition including on a W/W basis: (a) 67-85% oil; (b) 15-33% water; and (c) 0.15 to 0.3% arrowroot relative to water; wherein the composition is an emulsion at from a melting point of the oil to at least 60° C. In some embodiments, the arrowroot includes Canna. Alternatively or additionally, in some embodiments the oil includes a palm oil and/or coconut oil. Alternatively or additionally, in some embodiments the composition includes no emulsifier other than the arrowroot.

In some exemplary embodiments of the invention there is provided a composition including on a W/W basis: (a) 67-85% oil; (b) 15-33% water; and (c) 2.5 to 3.5% arrowroot relative to water; wherein the composition is a stable emulsion at 4° C. to 90° C. In some embodiments, the arrowroot includes Canna. Alternatively or additionally, in some embodiments the oil includes a palm oil and/or coconut oil. Alternatively or additionally, in some embodiments the composition includes no emulsifier other than the arrowroot.

In some exemplary embodiments of the invention there is provided a method including: (a) preparing an emulsion including coconut oil, water and arrowroot powder; and (b) manipulating the emulsion to produce beta prime crystal structure in the coconut oil. In some embodiments, the arrowroot powder includes Canna arrowroot. Alternatively or additionally, in some embodiments the manipulating includes: melting fat; cooling; reheating; and tempering. Alternatively or additionally, in some embodiments the emulsion includes lecithin.

In some exemplary embodiments of the invention there is provided a method including: (a) melting coconut fat to produce a liquid oil; (b) cooling the oil until it crystallizes; (c) reheating to dissolve the crystals; and (d) tempering. In some embodiments, the melting includes heating to at least 70° C. Alternatively or additionally, in some embodiments the melting has a duration of at least 10 minutes.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of the recited feature.

The phrase “consisting essentially of or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component. For purposes of this specification and the accompanying claims, the phrase” or non-lecithin conventional emulsifiers” includes, but is not limited to Alginic acid or salts thereof, Agar, Carrageenan, Processed eucheuma seaweed, Bakers yeast glycan, Arabinogalactan, Locust bean gum (Carob gum), Oat gum, Guar gum, Tragacanth, Acacia gum, Xanthan gum, Karaya gum, Tara gum, Gellan gum, Gum ghatti, Sorbitol, Mannitol, Glycerol, Curdlan, Konjac, Konjac gum, Konjac glucomannane, Soybean hemicellulose, Cassia gum, Peptones, Polyoxyethene (8) stearate, Polyoxyethene (40) stearate, Polyoxyethene (20) sorbitan monolaurate (polysorbate 20), Polyoxyethene (20) sorbitan monooleate (polysorbate 80), Polyoxyethene (20) sorbitan monopalmitate (polysorbate 40), Polyoxyethene (20) sorbitan monostearate (polysorbate 60), Polyoxyethene (20) sorbitan tristearate (polysorbate 65), Pectins, amidated pectin, Gelatine, Ammonium phosphatides, Brominated vegetable oil, Sucrose acetate isobutyrate, Glycerol esters of wood rosins, Succistearin, Diphosphates (i) Disodium diphosphate (ii) Trisodium diphosphate (iii) Tetrasodium diphosphate (iv) Dipotassium diphosphate (v) Tetrapotassium, diphosphate (vi) Dicalcium diphosphate (vii) Calcium dihydrogen diphosphate, Triphosphates (i) Sodium triphosphate (pentasodium triphosphate) (ii) Pentapotassium triphosphate, Polyphosphates (i) Sodium polyphosphates (ii) Potassium polyphosphates (iii) Sodium calcium polyphosphate (iv) Calcium polyphosphates (v) Ammonium polyphosphate, Beta-cyclodextrin, Cellulose (i) Microcrystalline cellulose (ii) Powdered cellulose, Methyl cellulose, Ethyl cellulose, Hydroxypropyl cellulose, Hypromellose (hydroxypropyl methylcellulose), Ethyl methyl cellulose, Carboxymethyl cellulose, Sodium carboxy methyl cellulose, Ethyl hydroxyethyl cellulose, Crosslinked sodium carboxymethyl cellulose (Croscarmellose), Enzymically hydrolysed carboxymethylcellulose salts of fatty acids, Magnesium salts of fatty acids), Mono- and diglycerides of fatty acids (glyceryl monostearate, glyceryl distearate), Acetic acid esters of mono- and diglycerides of fatty acids, Lactic acid esters of mono- and diglycerides of fatty acids, Citric acid esters of mono- and diglycerides of fatty acids, Tartaric acid esters of mono- and diglycerides of fatty acids, Mono- and diacetyl tartaric acid esters of mono- and diglycerides of fatty acids, Mixed acetic and tartaric acid esters of mono- and diglycerides of fatty acids, Succinylated monoglycerides, Sucrose esters of fatty acids, Sucroglycerides, Polyglycerol esters of fatty acids, Polyglycerol polyricinoleate, Propane-1,2-diol esters of fatty acids, propylene glycol esters of fatty acids, Lactylated fatty acid esters of glycerol and propane-1, Thermally oxidized soya bean oil interacted with mono- and diglycerides of fatty acids, Dioctyl sodium sulphosuccinate, Sodium stearoyl-2-lactylate, Calcium stearoyl-2-lactylate, Stearyl tartrate, Stearyl citrate, Sodium stearoyl fumarate, Calcium stearoyl fumarate, Sodium laurylsulphate, Ethoxylated Mono- and Di-Glycerides, Methyl glucoside-coconut oil ester, Propane-1,2-diol, Sorbitan monostearate, Sorbitan tristearate, Sorbitan monolaurate, Sorbitan monooleate, Sorbitan monopalmitate, Sorbitan trioleate, Polyoxypropylene-polyoxyethylene polymers, Partial polyglycerol esters of polycondensed fatty acids of castor oil, mono-glycerides, di-glycerides, mustard seed mucilage, a Pickering stabilization, Sodium Phosphate, Sodium stearoyl lactylate and Diacetyl Tartaric (Acid) Ester of Monoglyceride (DATEM).

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

According to various exemplary embodiments of the invention, steps of a method are performed in any order, not necessarily the depicted and/or described order.

Percentages (%) of chemicals and/or ingredients are W/W (weight per weight) unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a simplified flow diagram of a method according to some exemplary embodiments of the invention;

FIG. 2 is a simplified flow diagram of a method according to some exemplary embodiments of the invention;

FIG. 3 is a simplified flow diagram of a method according to some exemplary embodiments of the invention; and

FIG. 4 is a simplified flow diagram of another according to some exemplary embodiments of the invention.

### DETAILED DESCRIPTION OF EMBODIMENTS

Embodiments of the invention relate to emulsions and methods of producing them.

Specifically, some embodiments of the invention can be used as substitutes for margarine, shortening, mayonnaise, sour cream, and crème fraiche or as a base for food spreads (e.g. peanut butter, dulce de leche or chocolate spread)

The principles and operation of emulsions and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Method

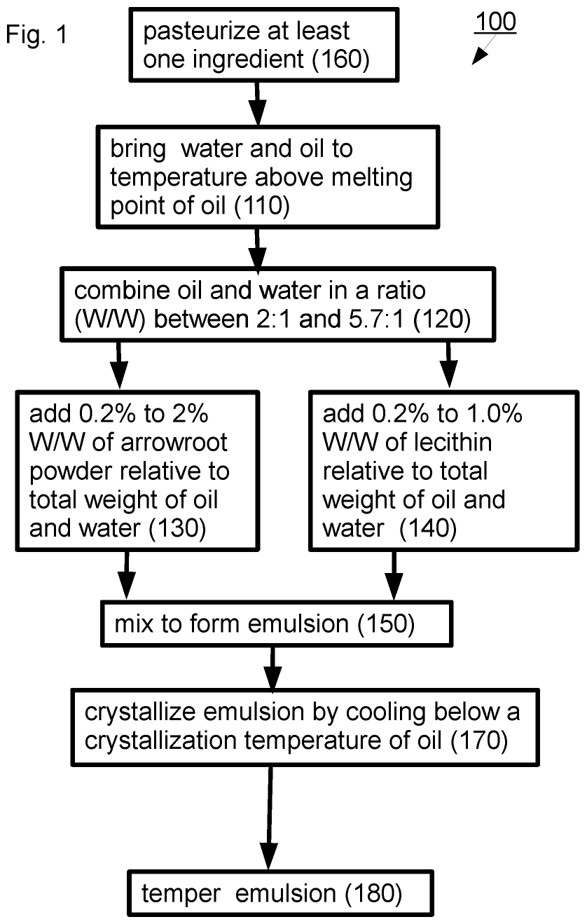

FIG. 1 is a simplified flow diagram of a method for emulsion preparation. Indicated generally as 100.

Depicted exemplary method 100 includes bringing 110 water and oil to a temperature above the melting point of the oil and combining 120 oil and water in a ratio (W/W) between 2:1 and 5.7:1. According to various exemplary embodiments of the invention the temperature above the melting point of the oil is 22° C., 30° C., 40° C., 50° C., 60° C., 70° C., 80° C., or intermediate or higher temperatures. In some exemplary embodiments of the invention, the temperature above the melting point of the oil is 30 degrees centigrade to 40 degrees centigrade.

In the depicted embodiment, method 100 includes adding 130 0.2% to 2% W/W of arrowroot powder relative to total weight of oil and water. In some embodiments adding 130 occurs after combining 120. In other exemplary embodiments of the invention, adding 130 occurs before or during combining 120.

In the depicted embodiment, method 100 includes adding 140 0.2% to 1.0% W/W of lecithin relative to total weight of oil and water. In some embodiments adding 140 occurs after combining 120. In other exemplary embodiments of the invention, adding 140 occurs before or during combining 120.

Depicted exemplary method 100 includes mixing 150 to form an emulsion. According to various exemplary embodiments of the invention, mixing 150 occurs after or during adding 130 and/or adding 140. In some embodiments, mixing 150 is conducted in a high shear mixer (e.g. a VITAMIX blender). In larger scale preparation, a homogenizer is substituted for the bender. One example of a homogenizer is EGLI high shear pump homogenizer.

In the depicted embodiment, method 100 includes pasteurizing 160 at least one ingredient selected from the group consisting of water, oil, arrowroot powder and lecithin. Alternatively or additionally, in some embodiments the emulsion formed at 150 is pasteurized.

Depicted exemplary method 100 includes crystallizing 170 the emulsion by cooling below a crystallization temperature of the oil.

In some embodiments adding 130 includes adding arrowroot to water prior to combining 120 oil and water. Alternatively or additionally, in some embodiments adding 140 includes adding lecithin to oil before combining 120 oil and water.

Depicted exemplary method 100 includes tempering 180 the emulsion. According to various exemplary embodiments of the invention tempering time is 6, 12, 18, 24, 30, 36, 42 or 48 hours or intermediate or longer times. In some embodiments, the tempering time is 10-14 hours, optionally about 12 hours. According to various exemplary embodiments of the invention tempering is conducted at a temperature greater than 20° C., greater than 21° C., greater than 22° C., greater than 24° C., greater than 26° C., greater than 28° C. or intermediate or higher temperatures. Alternatively or additionally, According to various exemplary embodiments of the invention tempering is conducted at a temperature less than 20° C., less than 21° C., less than 22° C., less than 24° C., less than 26° C., less than 28° C. or intermediate or lower temperatures. In some exemplary embodiments of the invention, tempering is conducted at about 22° C. to 25° C.

According to various exemplary embodiments of the invention, the arrowroot includes Marranta arrowroot and/or Curcuma arrowroot and/or Canna arrowroot.

According to various exemplary embodiments of the invention, the oil employed in method 100 includes, consists essentially of or consists of coconut oil.

According to various exemplary embodiments of the invention, the oil employed in method 100 includes, consists essentially of or consists any vegetable oil. Alternatively or additionally, in some embodiments the arrowroot comprises curcuma. For purposes of this specification and the accompanying claims, the term “vegetable oil” includes seed oils such as olive oil, soybean oil, rapeseed oil (Canola), grapeseed oil and hempseed oil. According to various exemplary embodiments of the invention, the emulsion formed at 150 is a water in oil emulsion or an oil in water emulsion.

### Additional Exemplary Method

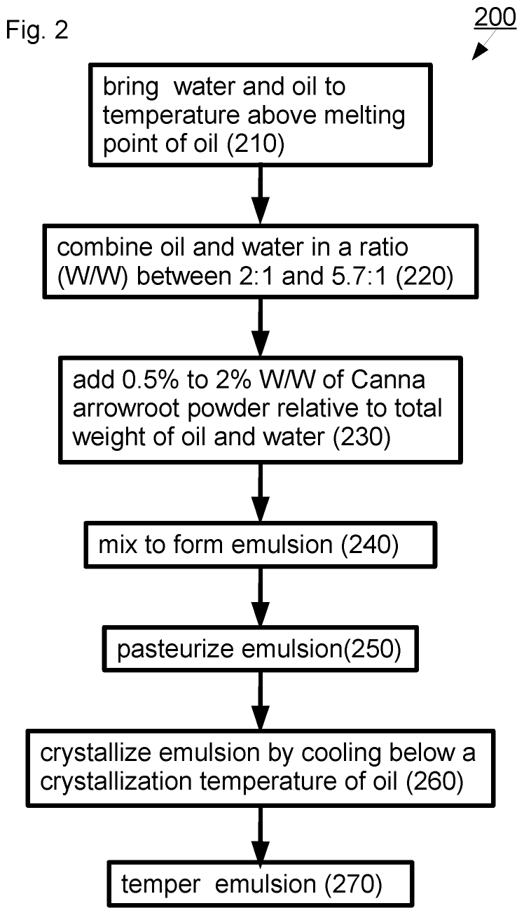

FIG. 2 is a simplified flow diagram of another method of emulsion preparation. Indicated generally as 200, according to some exemplary embodiments of the invention.

Depicted exemplary method 200 includes bringing 210 water and oil to a temperature above the melting point of the oil and combining 220 oil and water in a ratio (W/W) between 2:1 and 5.7:1. Depicted method 200 also includes adding 230 0.5% to 2% W/W of Canna arrowroot powder relative to total weight of oil and water and mixing 240 to form an emulsion. According to various exemplary embodiments of the invention adding 230 occurs before and/or during and/or after mixing 240 begins. Alternatively or additionally, in some embodiments mixing 240 is conducted in a high shear mixer as described above. In some embodiments, no lecithin or non-lecithin conventional emulsifying agent is employed.

In some exemplary embodiments of the invention, method 200 includes pasteurizing 250 the emulsion. In other exemplary embodiments of the invention, method 200 includes pasteurizing the oil and/or water and/or arrowroot powder.

Alternatively or additionally, in some embodiments method 200 includes crystallizing 260 the emulsion by cooling below a crystallization temperature of the oil.

Alternatively or additionally, in some embodiments method 200 includes tempering 270 the emulsion. Tempering 270 is similar to tempering 180 described hereinabove.

According to other exemplary embodiments of the invention adding 230 employs Marranta arrowroot and/or Curcuma arrowroot in addition to, or instead of, Canna arrowroot.

According to various exemplary embodiments of the invention, the temperature above a melting point of the oil is 22 degrees centigrade to 40 degrees centigrade. Alternatively or additionally, in some embodiments the oil comprises coconut oil, consists essentially of coconut oil or consists of coconut oil. In other exemplary embodiments of the invention, the oil comprises any vegetable oil. In some exemplary embodiments of the invention, adding 230 includes adding arrowroot to oil prior to combining 220.

### First Exemplary Composition

In some embodiments of the invention there is provided a composition including on a W/W basis:

67-85% oil;

15-33% water; and

0.2 to 3.0% arrowroot relative to water.

According to these embodiments, the composition is an emulsion stable from below the melting temperature of the oil to at least 40° C., 50° C., 60° C., 70° C., 80° C., 90° C. or intermediate or higher temperatures.

In some embodiments of this category, the oil includes coconut oil. Alternatively or additionally, in some embodiments of this category, the arrowroot includes Marranta and/or Canna and/or Curcuma. In some embodiments, use of Canna contributes to an increase in the temperature at which the emulsion remains stable. Alternatively or additionally, in some embodiments of this category, the composition includes 0.15% 2.85% lecithin W/W relative to the oil. According to various exemplary embodiments of the invention the amount of lecithin is 0.2%, 0.5%, 0.75%, 1%, 1.25%, 1.5%, 1.75%, 2%, 2.25%, 2.5% or intermediate or greater percentages W/W relative to the oil. In some embodiments, lecithin contributes to an increase in emulsion stability during rapid heating.

In some embodiments, increasing the amount of arrowroot contributes to an increase in emulsion thickness and/or spares a requirement for lecithin. Alternatively or additionally, in some embodiments an emulsion prepared without lecithin, or with low concentrations of lecithin, has desirable flavor and/or color and/or aroma.

In some exemplary embodiments of the invention, a combination of a relatively large amount of arrowroot and a relatively small amount of lecithin provides the desired texture without perceptible adverse effect on flavor and/or color and/or aroma.

### Second exemplary composition

In some embodiments of the invention there is provided a composition including on a W/W basis:

67-85% coconut oil;

15-33% water; and

2.0 to 3.0% arrowroot relative to water.

According to these embodiments, the composition is an emulsion stable when heated to a temperature of 170° C., 180° C., 190° C., 200° C., 210° C. or intermediate or higher temperatures. According to these embodiments, relatively high concentrations of arrowroot contribute to an increase in the temperature at which the emulsion remains stable.

According to various exemplary embodiments of the invention, the arrowroot includes Marranta and/or Canna and/or Curcuma. In some exemplary embodiments of the invention, the arrowroot comprises Cana Arrowroot. In some exemplary embodiments of the invention, the arrowroot consists essentially of Canna Arrowroot.

Alternatively or additionally, in some embodiments the composition includes 0.15%-2.85% lecithin W/W relative to the oil. According to various exemplary embodiments of the invention the amount of lecithin is 0.2%, 0.5%, 0.75%, 1%, 1.25%, 1.5%, 1.75%, 2%, 2.25%, 2.5% or intermediate or greater percentages W/W relative to the oil.

### Third Exemplary Composition

In some embodiments of the invention there is provided a composition including on a W/W basis:

67-85% oil;

15-33% water;

0.2 to 3.0% arrowroot relative to water.

According to these embodiments, the composition does not include lecithin yet is a stable emulsion at 4° C. to 30° C., 40° C., 50° C., 60° C., 70° C., 80° C., 90° C. or intermediate or higher temperatures. In some embodiments, an increase in the rate of temperature change contributes to a decrease in the upper limit of the temperature at which the emulsion remains stable. In some exemplary embodiments of the invention, the emulsion is stable at higher temperatures as well.

In some embodiments, the arrowroot includes Canna. Alternatively or additionally, in some embodiments the oil includes a palm oil, for example coconut oil. In some embodiments, the emulsion does not comprise lecithin. Alternatively or additionally, in some embodiments the composition does not comprise any non-lecithin conventional emulsifier.

### Fourth Exemplary Composition: Butter or Margarine Substitute

In some embodiments of the invention there is provided a composition including on a W/W basis:

67-85% oil;

15-33% water; and

1.2 to 1.6% arrowroot relative to water.

According to these embodiments, the composition is a stable emulsion at 4° C. to 30° C., 40° C., 50° C., 60° C., 70° C., 80° C., 90° C. or intermediate or higher temperatures. In some embodiments, the emulsion is stable at higher temperatures.

According to various exemplary embodiments of the invention, the arrowroot includes Marranta and/or Canna, and/or Curcuma. Alternatively or additionally, in some embodiments the composition includes lecithin. In other exemplary embodiments of the invention, the composition does not include lecithin. In some embodiments Maranta and/or Curcuma are used in conjunction with lecithin

Alternatively or additionally, in some embodiments the oil includes a palm oil, for example coconut oil.

In some embodiments, the composition includes no emulsifier other than the arrowroot.

Embodiments of this type have similar properties to butter or margarine. In those embodiments without lecithin, the composition may not stay emulsified when rapidly heated, but can be used in cold applications as spreading on bread or crackers.

In some exemplary embodiments of this type a relatively high percentage of Canna arrowroot contributes to an increase in emulsion is thickness and/or to a butter like texture when cooled. In some embodiments Due to the lack of lecithin, rapid heating will cause the product to coalesce. In some exemplary embodiments of this type, addition of a small amount of lecithin increase the maximum temperature at which the emulsion is stable, for example to 90° C.

### Fifth Exemplary Composition: Mayonnaise Like Consistency

In some embodiments of the invention there is provided a composition including on a W/W basis:

67-85% oil;

15-33% water; and

0.15 to 0.3% arrowroot relative to water.

According to these embodiments, the composition is a stable emulsion at from a melting point of said oil to at least 60° C.

In some exemplary embodiments of this type, lower ratios of arrowroot contribute to a reduction in emulsion thickness. Alternatively or additionally, in some embodiments, use of an unsaturated liquid oil, such as a seed oil (e.g. Canola or corn oil), is used, a mayonnaise like texture is achieved. In other exemplary embodiments of the invention, use of a highly saturated oil, such as coconut oil, produces a spread.

According to various exemplary embodiments of the invention, the arrowroot includes Marranta and/or Canna and/or Curcuma. In some exemplary embodiments of the invention, Canna is used without lecithin or other non-lecithin conventional emulsifiers. Alternatively or additionally, in some embodiments the oil includes a palm oil, such as coconut oil. Alternatively or additionally, in some embodiments the composition includes no emulsifier other than the arrowroot.

Compositions of this type are similar in texture and mouth feel to mayonnaise or a spread.

### Sixth Exemplary Composition: Sour Cream/Crème Fraiche Substitute

In some embodiments of the invention there is provided a composition including on a W/W basis:

67-85% oil;

15-33% water; and

2.5 to 3.5% arrowroot relative to water.

According to these embodiments, the composition is an emulsion at 4° C. to 30° C., 40° C., 50° C., 60° C., 70° C., 80° C., 90° C., or intermediate or higher temperatures.

In some exemplary embodiments of this type, higher ratios of arrowroot contribute to a texture that is evocative of sour cream or crème fraiche.

According to various exemplary embodiments of the invention, the arrowroot includes Marranta and/or Canna and/or Curcuma. In some exemplary embodiments of the invention, Canna is used without lecithin or other non-lecithin conventional emulsifiers. Alternatively or additionally, in some embodiments the oil includes a palm oil such as coconut oil. Experiments suggest that many oils emulsify at this texture. According to various exemplary embodiments of the invention, the melting point of the oil contributes to the consistency and/or texture of the emulsion.

In some embodiments, a low melting point oil (e.g. olive oil, flax seed oil, canola oil or soybean oil) contributes to a cream like consistency. In other exemplary embodiments of the invention, a high melting point oil (e.g. coconut oil, cocoa butter, palm oil) contributes to a spread like consistency.

In some exemplary embodiments of the invention, there is no emulsifier other than the arrowroot. In other exemplary embodiments of the invention, lecithin is included. In some embodiments including lecithin, the arrowroot includes Marranta and/or Curcuma.

Exemplary Crystal Structure Manipulation Methods

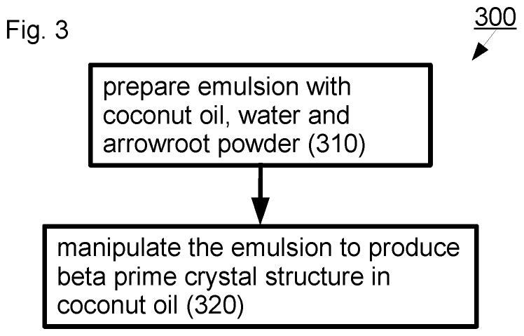

FIG. 3 is a simplified flow diagram of a method for crystal structure manipulation indicated general as 300.

Depicted exemplary method 300 includes preparing 310 an emulsion comprising coconut oil, water and arrowroot powder and manipulating 320 the emulsion to produce beta prime crystal structure in the coconut oil. In some embodiments, the arrowroot powder includes Canna arrowroot. Alternatively or additionally, in some embodiments manipulating 320 includes melting fat and/or cooling and/or reheating and/or tempering. Alternatively or additionally, in some embodiments the emulsion includes lecithin. Exemplary manipulation protocols are set forth hereinbelow in Examples 13 and 14.

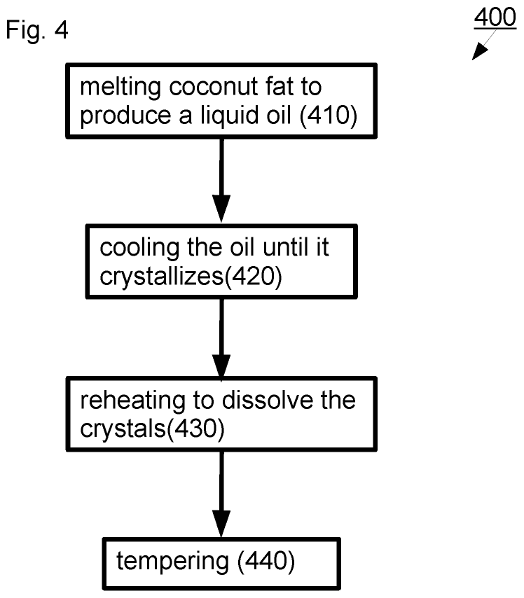

FIG. 4 is a simplified flow diagram of another method for crystal structure manipulation indicated general as 400.

Depicted exemplary method 400 includes melting 410 coconut fat to produce a liquid oil and 420 cooling the oil until it crystallizes and reheating 430 to dissolve the crystals and tempering 440.

In some embodiments, melting 410 includes heating to at least 70° C. Alternatively or additionally, in some embodiments melting 410 has a duration of at least 10 minutes. In some exemplary embodiments of the invention, maintaining a temperature of at least 70° C. for at least 10 minutes during melting 410 melts all existing crystal structures completely.

These processes are set forth hereinbelow in Examples 13 and 14.

Exemplary Crystal State Manipulation Considerations

Coconut oil has different crystalline structures. There are Alpha crystals, which are unstable and with time usually revert to Beta, and Beta Prime crystals. Beta prime crystals have the highest melting point compared to Alpha and Beta crystals.

Beta Prime crystals contribute to a shiny appearance and/or a smooth texture similar to chocolate, which is processed to achieve a Beta Prime crystal structure in the Cocoa butter.

The ability to control the crystallization of coconut fat contributes to an ability to manipulate texture and mouthfeel in margarine and when creating a whippable product based on coconut fat. Many additional products would benefit from the ability to manipulate the crystallization of coconut fat to achieve a desired crystal structure. For example, Margarine, spreads and chocolate based on coconut oil instead of cocoa butter.

In some exemplary embodiments of the invention, a predominantly beta prime fat is achieved by melting the fat to ensure the existing crystal network is destroyed and cooling to create beta crystals followed by reheating to melt alpha crystals and tempering to melt Alpha crystals and to force unstable crystals to Beta Prime structure.

The methods depicted in FIGS. 3 and 4 as well as Examples 13 and 14 illustrate exemplary ways to achieve these goals.

Exemplary Advantages

In some exemplary embodiments of the invention, use of an emulsion containing water reduces the caloric content of a food product (e.g. margarine or mayonnaise).

In some exemplary embodiments of the invention, use of a saturated oil, such as coconut oil or palm oil, reduces the need for hydrogenation and/or esterification.

Exemplary Optional Ingredients

Within the context of each of the various methods and compositions described hereinabove, the following optional ingredients are used to create additional embodiments of the invention.

In some exemplary embodiments of the invention, the oil includes hemp oil. Alternatively or additionally, in some embodiments the oil includes an extract of cannabis. Alternatively or additionally, in some embodiments the water includes an extract of cannabis.

In some exemplary embodiments of the invention, the oil includes one or more flavoring agents. Alternatively or additionally, in some embodiments the water includes one or more flavoring agents.

It is expected that during the life of this patent, many new types of homogenizer and blenders will be developed and the scope of the invention is intended to include all such new technologies a priori.

It is expected that during the life of this patent many new types of arrowroot preparations (for example, leaves and/or extract of arrowroot) will be developed and the scope of the invention is intended to include all such new technologies a priori.

As used herein the term “about” refers to ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of certain oils but might also be used with other oils. Alternatively or additionally, the invention has been described in the context of food products but is expected to find use also in the soap and cosmetic industries.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non-limiting fashion.

The following materials and methods are used in performance of experiments described in examples hereinbelow:

Materials:

Lecithin: Soy lecithin and de-oiled sunflower lecithin were used interchangeably with similar results.

Soy lecithin was Organic soy lecithin (Oleoland, Ukraine; Origin, India)

Sunflower lecithin was European Deoiled non GMO pure sunflower lecithin, (Ivivotal, Germany).

Coconut oil: RBD (refined, bleached, and deodorized) Coconut oil from Do-It (Netherlands) prepared from Phillipine oil. Fat is not hydrogenated or interesterified,

Similar results were achieved with virgin coconut oil (data not shown). Maranta Arundinacea starch (Banana Rhizome extract): (Bergwerf, India) commonly known as East Indian arrowroot.

Canna Indica starch: (Amarlane foods; Israel) Starch was produced using standard starch extraction process. Canna indica roots were washed, cleaned, washed again, drained, pulped, sieved dryed and packed. No additives were introduced.

Curcuma Angustifolia starch: (Sheily indo proteins, India) Also commonly known as East Indian arrowroot.

Equipment:

Blender: Vitamix—VMFS019 (Vitamix Corporation; Cleveland Ohio; USA)

EGL1 crystallizer—EGLI, Butchwill, Switzerland.

Adamas (Heat Exchanger)—Butter extruder machine, (Agropois, Ukraine)

Glycol based cooling system—Generic chiller (EGLI, Butchwill, Switzerland).

Ammonia based cooling system—Generic chiller (EGLI, Butchwill, Switzerland).

Ice water based cooling system—Generic water based chiller (Agropois, Ukraine).

### Example 1

### Maranta Arundinacea as an Emulsion Stabilizer

In order to examine the possibility of using Maranta Arundinacea as an emulsion stabilizer, the following recipe was used:

| | |
|---|---|
| RBD Coconut oil | 66% |
| Water | 32% |
| lecithin | 0.2% |
| Maranta Arundinacea starch | 1.8% |

All ingredients were brought to 30 degrees centigrade. The lecithin was dissolved in the liquid coconut oil to make an oil phase and the starch was dissolved in water to make a water phase. The water phase was placed in the blender at speed setting 8. The oil phase was added gradually until a homogeneous mixture was achieved. The emulsion texture was similar to heavy cream and was stable for 15 minutes. This time was sufficient for refrigeration to crystallize the coconut oil to create a margarine like product. Crystallization (as detailed in FIG. 3 and accompanying descriptive text as well as examples 13 and 14 hereinbelow) produced a margarine like product with no discernible separation of oil and water. Use of starch permitted use of less lecithin than similar processes without starch as well as thickening texture and prolonging the coalescence of oil droplets.

### Example 2

### Low Amounts of Maranta Arundinacea are Ineffective for Emulsion Stabilization

In order to examine the possibility of using significantly less Maranta Arundinacea as an emulsion stabilizer, the following recipe was used:

| | |
|---|---|
| RBD Coconut oil | 67% |
| Water | 32.6% |
| lecithin | 0.2% |
| Maranta Arundinacea starch | 0.2% |

The process was as described above in Example 1. The resultant mixture was thin and liquid with oil and water phases clearly visible. This example illustrates that 0.2% Maranta Arundinacea starch is insufficient for emulsion stabilization.

### Example 3

### Higher Amounts of Maranta Arundinacea Thicken the Emulsion

In order to examine the possibility of using significantly more Maranta Arundinacea as an emulsion stabilizer, the following recipe was used:

| | |
|---|---|
| RBD Coconut oil | 66% |
| Water | 31% |
| lecithin | 0.5% |
| Maranta Arundinacea starch | 2.5% |

The process was as described above in Example 1 except that the blender speed was 4. The resultant mixture had a mayonnaise like texture with no discernible separation of oil and water phases during 15 minutes. This time was sufficient for refrigeration to crystallize the coconut oil. Crystallization (as detailed in FIG. 3 and accompanying descriptive text as well as examples 13 and 14 hereinbelow) produced a margarine like product with no discernible separation of oil and water. This example suggests that 2.5% starch thickens the emulsion considerably.

### Example 4

### Higher Amounts of Lecithin Reduce Emulsiuon Stability

In order to examine the possibility of Maranta Arundinacea as an emulsion stabilizer in the presence of high amounts of lecithin, the following recipe was used:

| | |
|---|---|
| RBD Coconut oil | 66% |
| Water | 30% |
| lecithin | 2.5% |
| Maranta Arundinacea starch | 1.5% |

The process was as described above in Example 3. The resultant mixture had a mayonnaise like texture initially, but quickly separated into oil and water phases. There was not sufficient time for refrigeration to crystallize the coconut oil. This example shows excess lecithin, widely regarded as an emulsifying agent, prevents the arrowroot from properly stabilizing the emulsion.

Examples 1-4 illustrate that 1.8% to 2.5% starch in the presence of 0.2 to 0.5% Lecithin can stabilize an emulsion based on 66% oil and water for sufficient time to make a margarine like product.

### Example 5

### Canna Indica as an Emulsion Stabilizer

In order to examine the possibility of using Canna Indica as an emulsion stabilizer, the following recipe was used:

| | |
|---|---|
| RBD Coconut oil | 66.8% |
| Water | 32% |
| lecithin | 0.2% |
| Canna Indica starch | 1.0% |

All ingredients were brought to 30 degrees centigrade. The lecithin was dissolved in the liquid coconut oil to make an oil phase and the starch was dissolved in water to make a water phase. The water phase was placed in the blender at speed setting 4. The oil phase was added gradually until a homogeneous mixture was achieved. The emulsion texture was similar to heavy cream and was stable for up to 48 hours or more at up to 82° C. Crystallization (as detailed in FIG. 3 and accompanying descriptive text as well as examples 13 and 14 hereinbelow) produced a margarine like product with no discernible separation of oil and water. Use of 1.0% Canna starch properly stabilized the emulsion as effectively as or more effectively than mono and diglycerides commonly used to for the same function. This example, together with Example 1, suggests that Canna Indica starch is a more effective stabilizer than Maranta Arundinacea starch.

### Example 6

### Increasing Lecithin Amount does not Reduce Effectiveness of Canna Indica as an Emulsion Stabilizer

In order to examine the possibility of using higher amounts of lecithin with Canna Indica, the following recipe was used:

| | |
|---|---|
| RBD Coconut oil | 66.8% |
| Water | 32% |
| lecithin | 1.0% |
| Canna Indica starch | 1.0% |

The process was as described above in Example 5. As in Example 5, the emulsion texture was similar to heavy cream and was stable for up to 48 hours or more at up to 82° C. Crystallization (as detailed in FIG. 3 and accompanying descriptive text as well as examples 13 and 14 hereinbelow) produced a margarine like product with no discernible separation of oil and water. This example, together with Example 4, suggests that Canna Indica starch is a more effective stabilizer in the presence of high amounts of lecithin than Maranta Arundinacea starch.

### Example 7

### Increasing Oil to Water Ratio does not Reduce Effectiveness of Canna Indica as an Emulsion Stabilizer

In order to examine the possibility of using Canna Indica for oil in water emulsions, the following recipe was used:

| | |
|---|---|
| RBD Coconut oil | 82% |
| Water | 16.5% |
| lecithin | 0.5% |
| Canna Indica starch | 1.0% |

The process was as described above in Example 5. As in Example 5, the emulsion texture was similar to heavy cream and was stable for up to 48 hours at up to 82° C. Crystallization produced a margarine like product with no discernible separation of oil and water. This example, together with Example 4, suggests that Canna Indica starch is a more effective stabilizer in the presence of high amounts of lecithin than Maranta Arundinacea starch.

### Example 8

### Canna Indica as an Emulsifier

In order to examine the possibility of using Canna Indica without a conventional emulsifier, the following recipe was used:

| | |
|---|---|
| RBD Coconut oil | 67% |
| Water | 32% |
| lecithin | NONE |
| Canna Indica starch | 1.0% |

The process was as described above in Example 5 except that no lecithin was added to the oil. The emulsion texture was mayonnaise like and was stable indefinitely. This example demonstrates the possibility of making a reduced fat mayonnaise like or spread product using starch as an emulsifier instead of lecithin. These results suggest that similar results can be achieved in any process where there is no rapid heating of the product.

### Example 9

### Low Amounts of Canna Indica as an Emulsifier

In order to examine the possibility of reducing the amount of Canna Indica, the following recipe was used:

| | |
|---|---|
| RBD Coconut oil | 66.5% |
| Water | 33% |
| lecithin | NONE |
| Canna Indica starch | 0.5% |

The process was as described above in Example 8 except that ingredient were brought to 40 degrees centigrade. The emulsion texture was similar to heavy cream and was stable indefinitely. This example demonstrates the possibility of making a reduced fat cream like product using canna starch as an emulsifier instead of lecithin or other non-lecithin conventional emulsifying agents.

### Example 10

### Canna Indica as an Emulsifier in an Oil in Water Emulsion

In order to examine the possibility of reducing the amount of oil in the emulsion, the following recipe was used:

| | |
|---|---|
| RBD Coconut oil | 30% |
| Water | 68% |
| lecithin | NONE |
| Canna Indica starch | 2% |

The process was as described above in Example 8. The emulsion texture was similar to heavy cream and was stable indefinitely. This example demonstrates the possibility of using Canna starch for an oil in water emulsion as well, making a cream like product with only 30% fat using starch as an emulsifier instead of lecithin or any other conventional emulsifying agent.

### Example 11

### Influence of Arrowroot Type and Amount on Properties of Emulsion Including Lecithin

Different amounts and types of Arrowroot Starch were tested to determine the amount of starch needed to stabilize a water in oil emulsion using 0.15%-2.85% of oil weight of lecithin as the surfactant (emulsifier) and using Arrowroot Starch as the stabilizer to prevent the coalescence of oil droplets.

Results were as follows:

| % arrowroot | | |
|---|---|---|
| relative to water | | |
| W/W | Marranta arrowroot | Canna Arrowroot |
| 4%-7% | Emulsion stable for | Not done |
| | 15 minutes | |
| | Similar to heavy cream | |
| 0.23% | Not done | Emulsion stable for 48 hours |
| | | Similar to 15% fat cream |
| 1.4% | Not done | Emulsion stable for 48 hours |
| | | Similar to butter/margarine |
| 2.9% | Not done | Emulsion stable for 48 hours |
| | | Similar to Mayonnaise |

Maranta stabilized the emulsion for up to 15 minutes.

Canna Starch was found to be effective when the water to oil ratio was between 15%-33% of the oil weight for much longer. Tests showed that varying the amount of Canna Starch in the range of 0.23%-2.9% of water weight changed emulsion properties dramatically. 1.4% Canna starch gave a solid emulsion similar to butter or margarine, while lower or higher percentages gave softer emulsions.

### Example 12

### Influence of Canna Starch Amount on Properties of Emulsion without Lecithin

Different amounts of Canna Starch were tested to determine the amount of starch needed to stabilize an emulsion without lecithin. Emulsions were stable indefinitely at all tested concentrations.

Results were as follows:

| % Canna relative to water | |
|---|---|
| W/W | Canna Arrowroot |
| 0.23% | thin texture |
| | Similar to 15% fat cream |
| 1.4% | Similar to butter/margarine |
| 2.9% | Similar to mayonnaise or spread |

Results of this example, together with those of example 11, suggest that water/oil emulsions with a wide range of textures can be prepared using canna starch as the sole emulsifier.

### Example 13

### Motion Crystallization of Coconut Oil Based Emulsions

In order to create a beta prime coconut oil crystal structure in an emulsion, the following protocol was performed.

An emulsion was prepared as in Example 1.

The emulsion was placed in an EGLI crystallizer.

The oil in the emulsion was melted by heating to 70° C. for ten minutes.

The outer shaft of the crystallizer was cooled to −9° C. while scraping the crystallized oil from the inside shaft. This process is believed to create beta crystals.

The inner shaft of the crystallizer was heated above the melting temperature of alpha crystals in order to achieve a beta prime stable fat. The process is complete when the emulsion exiting the crystallizer reaches 21.5° C. to 23° C.

Heat created by friction of the pinworker of the crystallizer melts remaining alpha crystals and prevents formation of new beta crystals.

The emulsion was then tempered at 22° C. to 28° C. for 12 hours to promote formation of beta prime crystals as the dominant crystal structure.

Three tests were performed with varying conditions:

| Parameter | First test | | Second Test | Third test | |
|---|---|---|---|---|---|
| Outside shaft | −9° | C. | −9° C. | −15° | C. |
| temperature | | | | | |
| Inside shaft | 40° | C. | 40° C. | 30° | C. |
| temperature | | | | | |
| Product output | 21.5° | C. | 25° C. | 18° | C. |
| temperature from | | | | | |
| crystallizer | | | | | |
| Product output | 22° | C. | 25° C. | 18.5° | C. |
| temperature from | | | | | |
| pin worker | | | | | |
| Tempering | 25° | C. | N/A | 15° | C. |
| temperature | | | | | |

| | | | |
|---|---|---|---|
| Result | Beta prime stable | Fat didn't crystallize | beta crystals |
| | product | properly | to dominate |

In the first test, a beta prime stable product was achieved. In the second test, the fat did not crystallize properly because of insufficient cooling. Too many unstable crystals were present due to the high temperature of the product output from the crystallizer. In the third test the fat was over-cooled to a point where melting of remaining alpha crystals was hard to achieve causing the beta crystals to dominate. This resulted in a product output with a low temperature which is below melting point of alpha crystals.

These three tests suggest that if the four stages of:
Melting fat to destroy crystal network;
Cooling to create beta crystals;
Reheating to melt alpha in order to create beta prime crystals; and
Tempering
   are performed correctly while output temperature is between 21.5° C. to 23° C., a product with predominately beta prime crystals will result. Settings of equipment can be manipulated to keep the output temperature in the desired range.

### Example 14

### Stationary Tempering to Control Crystallization of Coconut Oil and/or Coconut Oil Based Emulsions

In order to increase the amount of beta prime coconut oil crystals in oil and/or an emulsion based on coconut oil, the following protocol was performed.

An emulsion as described in Example 13 was prepared.

A temperature controlled box with a first temperature sensor for the tempering apparatus and a second temperature sensor for the emulsion temperature was prepared using a thermoelectric plate as a temperature regulator.

The oil in the emulsion was melted by heating to 70° C. for ten minutes.

The box temperature was set below 24° C. and the coconut oil in the emulsion was allowed to crystallize, forming beta crystals.

The box temperature was raised above 22° C., but not above 25° C., to melt alpha crystals and encourage formation of beta prime crystals.

Remaining alpha crystals were melted by tempering for 12 hours.

Four tests were performed with varying conditions and the results were as follows:

| | First | Second | Third | Fourth |
|---|---|---|---|---|
| Parameter | test | Test | test | test |
| Initial melting | 70° C. | 70° C. | 70° C. | 70° C. |
| of crystals | | | | |
| Formation of | 21° C. | 15° C. | 15° C. | 21° C. |
| unstable beta | | | | |
| crystals | | | | |
| Heating to melt | 24° C. | 21° C. | 21° C. | 27° C. |
| alpha crystals | | | | |
| Tempering (12 | 25° C. | N/A | 21° C. | N/A |
| hours) | | | | |
| Result | Beta prime | Beta crystals | Beta crystals | Fat was |
| | stable product | dominate | dominate | melted |

The first test produced a product where beta prime crystals appeared to dominate.

In the second test Beta crystals dominated. In order to create beta prime stable product, higher temperature was required at the third stage or alpha won't melt, thus causing the fat to revert to its natural beta crystal structure.

In the third test Beta crystals dominated. In order to create beta prime stable product, higher temperature was required at the third stage or alpha won't melt, thus causing the fat to revert to its natural beta crystal structure.

In the fourth test, the fat was melted. During stage 3 fat was heated to a temperature where alpha and beta crystals melted. This prevented controlled melting of alpha crystals, a necessary step to create a beta prime stable fat.

The first, second, third and fourth tests were repeated with RBD coconut oil and similar results were achieved.

### Example 15

### Curcuma Angustifolia as an Emulsion Stabilizer

In order to examine the possibility of using Maranta Arundinacea as an emulsion stabilizer, the following recipe was used:

| | |
|---|---|
| RBD Coconut oil* | 66% |
| Water | 32% |
| lecithin | 0.2% |
| Curcuma angustifolia starch | 1.8% |

All ingredients were brought to 30° C. and the emulsion was prepared as in Example 1 except that the starch was Curcuma Angustifolia. The speed setting on the blender was 8 and the emulsification temperature was 30° C. The resultant emulsion had the texture of heavy cream and was stable for about 15 minutes. Curcuma angustifolia starch stabilized the emulsion for sufficient time to complete the production process of a product such a margarine. Once the crystallization takes place it solidifies the product and stabilizes the emulsion. Alternatively or additionally, the starch enriches the emulsion texture allowing the use of less lecithin.

### Example 16

### Lower Amounts of Curcuma Angustifolia as an Emulsion Stabilizer

In order to examine the possibility of using lower amounts of Maranta Arundinacea as an emulsion stabilizer, the following recipe was used:

| | |
|---|---|
| RBD Coconut oil* | 67% |
| Water | 32.6% |
| lecithin | 0.2% |
| Curcuma angustifolia starch | 0.2% |

All ingredients were brought to 30° C. and the emulsion was prepared as in Example 15. The resultant emulsion was thin and liquid and unstable. This test indicates that 0.2% of Maranta Arundinacea starch was an ineffective emulsion stabilizer.

### Example 17

### Higher Amounts of Curcuma Angustifolia as an Emulsion Stabilizer

In order to examine the possibility of using higher amounts of Maranta Arundinacea as an emulsion stabilizer, the following recipe was used:

| | |
|---|---|
| RBD Coconut oil* | 66% |
| Water | 31% |
| lecithin | 0.5% |
| Curcuma angustifolia starch | 2.5% |

All ingredients were brought to 30° C. and the emulsion was prepared as in Example 15 except that the speed setting on the blender was 4. The resultant emulsion had a mayonnaise like consistency and was stable for 15 minutes. As in Example 15, Curcuma angustifolia starch stabilized the emulsion for sufficient time to complete the production process of a product such a margarine. Once the crystallization takes place it solidifies the product and stabilizes the emulsion.

### Example 18

### Curcuma Angustifolia as an Emulsion Stabilizer with High Amounts of Lecithin

In order to examine the possibility of using higher amounts of lecithin, the following recipe was used:

| | |
|---|---|
| RBD Coconut oil | 66% |
| Water | 30% |
| lecithin | 2.5% |
| Curcuma angustifolia starch | 1.5% |

All ingredients were brought to 30° C. and the emulsion was prepared as in Example 15 except that the speed setting on the blender was 4. The resultant emulsion had a mayonnaise like consistency but was not stable for any significant amount of time. Surprisingly, increasing the amount of lecithin contributed to a decrease in the stabilizing effect of the Curcuma angustifolia starch.

1. A method comprising:
(a) bringing water and oil to a temperature above the melting point of the oil;
(b) combining oil and water in a ratio (W/W) between 2:1 and 5.7:1
(c) adding 0.5% to 2% W/W of Canna arrowroot powder relative to total weight of oil and water; and
(e) mixing to form an emulsion.

2. A method according to claim 1, wherein said mixing is conducted in a high shear mixer.

3. A method according to claim 1, comprising crystallizing said emulsion by cooling below a crystallization temperature of said oil.

4. A method according to claim 1, wherein said adding 0.2% to 2% W/W of arrowroot comprises adding arrowroot to water prior to combining oil and water.

5. A method according to claim 1, wherein said adding 0.2% to 2% W/W of arrowroot comprises adding arrowroot to oil prior to combining oil and water.

6. A method according to claim 1, comprising tempering said emulsion.

7. A method according to claim 1, wherein said arrowroot comprises Marranta arrowroot in addition to Canna.

8. A method according to claim 1, wherein said Arrowroot powder consists essentially of Canna Arrowroot.

9. A method according to claim 1, wherein said arrowroot powder comprises Curcuma arrowroot in addition to Canna.

10. A method according to any of claim 1, wherein said temperature above a melting point of the oil is 22° C. to 80° C.

11. A method according to claim 1, wherein said oil comprises coconut oil.

12. A method according to claim 11, wherein said oil consists essentially of coconut oil.

13. (canceled)

14. A method according to claim 1, wherein no emulsifier selected from the group consisting of lecithin and non-lecithin conventional emulsifying agents is added.

15-56. (canceled)

57. A method comprising:
(a) preparing an emulsion comprising coconut oil, water and arrowroot powder; and
(b) manipulating the emulsion to produce beta prime crystal structure in the coconut oil.

58. A method according to claim 57, wherein said arrowroot powder comprises Canna arrowroot.

59. A method according to claim 57, wherein said manipulating includes:
melting fat;
cooling;
reheating; and
tempering.

60. A method according to claim 57, wherein said emulsion comprises lecithin.

61. A method comprising:
(a) melting coconut fat to produce a liquid oil;
(b) cooling the oil until it crystallizes;
(c) reheating to dissolve the crystals; and
(d) tempering.

62. A method according to claim 61, wherein said melting comprises heating to at least 70° C.

63. A method according to claim 61, wherein said melting has a duration of at least 10 minutes.
